(19) United States
(12) Patent Application Publication
(10) Pub. No.: US 2017/0246943 A1
(43) Pub. Date: Aug. 31, 2017

(54) MOTOR VEHICLE WITH AT LEAST PARTIALLY ELECTRIC DRIVE

(71) Applicant: FORD GLOBAL TECHNOLOGIES, LLC, Dearborn, MI (US)

(72) Inventors: Martin SALZ-BREUER, Bonn (DE); Joergen HILMANN, Leverkusen (DE); Michael KEIMES, Neuss (DE)

(73) Assignee: FORD GLOBAL TECHNOLOGIES, LLC, Dearborn, MI (US)

(21) Appl. No.: 15/444,749

(22) Filed: Feb. 28, 2017

(30) Foreign Application Priority Data
Feb. 29, 2016 (DE) 10 2016 203 209.7

(51) Int. Cl. B60K 1/04; B60L 11/18; H01M 2/10; B60K 6/28

(52) U.S. Cl. CPC B60K 1/04; B60K 6/28; B60L 11/1877; H01M 2/1083; B60K 2001/0438; B60Y 2400/112; B60Y 2200/92; Y10S 903/907; H01M 2220/20

(57) ABSTRACT

The disclosure concerns a motor vehicle with at least partially electric drive, having a floor structure of a motor vehicle bodyshell and a traction battery. The traction battery is arranged on an underside of the floor structure and is connected thereto. The floor structure has a central tunnel extending in the vehicle longitudinal direction and having a profile open towards the bottom. A plurality of reinforcing webs is arranged on the central tunnel, which stiffen the central tunnel and are fixedly connected thereto. The traction battery is attached at least to some of the reinforcing webs.

### CROSS-REFERENCE TO RELATED APPLICATIONS

This application claims foreign priority benefits under 35 U.S.C. §119(a)-(d) to DE Application 10 2016 203 209.7 filed Feb. 29, 2016, which is hereby incorporated by reference in its entirety.

### TECHNICAL FIELD

The present disclosure concerns a motor vehicle with at least partially electric drive.

### BACKGROUND

In such a motor vehicle, for example a hybrid electric vehicle with an internal combustion engine, a plug-in hybrid vehicle or a purely electric vehicle, a large traction battery must be accommodated in the motor vehicle that substantially guarantees the supply of electrical power to one or more electric motors for driving the motor vehicle. It is known to arrange such a traction battery below a floor structure of the bodyshell of the motor vehicle and to connect this thereto, as disclosed for example in U.S. Pat. No. 8,702,161 B2 and US 2015/0239331 A1.

A particular challenge in the development of the motor vehicle bodyshell is to make optimum use of the installation space, which is severely restricted by the ground clearance of the motor vehicle and the passenger cell. Also, the bodyshell must offer adequate stiffness in order to guarantee that the passenger cell and traction battery remain as intact as possible in the event of a collision of the motor vehicle with an obstacle. In addition, the vehicle bodyshell must offer fixing facilities e.g. for the traction battery and the vehicle seats.

U.S. Pat. No. 8,646,790 B2 furthermore discloses a vehicle superstructure of an electric vehicle for protecting a traction battery from damage on a frontal collision of the vehicle with an obstacle. On a frontal collision, part of a subframe of the vehicle bodyshell is pushed by means of ramp-like elements below the traction battery, protecting this damage.

DE 10 2012 108 816 A1 describes a battery carrier device for a vehicle, in which a vehicle battery may be arranged below a vehicle bodyshell and connected thereto. The vehicle battery comprises a battery pack arranged laterally to the left of a floor tunnel and a battery pack arranged laterally to the right of the floor tunnel. On a side impact, the battery carrier device allows the battery pack to be displaced in the vehicle transverse direction, protecting it from deformation or damage from the side impact force.

U.S. Pat. No. 7,836,999 B2 discloses a fuel cell accommodated in a central tunnel of the vehicle bodyshell.

Furthermore, US 2013/0229030 A1 describes a floor structure of a motor vehicle with a large battery unit arranged below the floor structure, wherein the floor structure is configured to protect the battery unit from deformation or damage in the event of a side impact. For this, an upper transverse web running in the vehicle transverse direction and a lower transverse web running in the vehicle transverse direction are provided, each of which is connected at its outer ends to longitudinal members running in the vehicle longitudinal direction. The battery unit is arranged between the two transverse webs so that on a side impact, the side impact force acting on one of the longitudinal members is received by the transverse webs and dissipated. The floor structure disclosed furthermore comprises a central tunnel through which the upper transverse web extends in the vehicle transverse direction, wherein a middle part of the upper transverse web is formed by a transverse web element passing through the central tunnel and attached thereto.

### SUMMARY

In this context, the present disclosure is based on the object of providing a motor vehicle with at least partially electric drive, such as a hybrid, plug-in hybrid or electric vehicle, with a floor structure of a motor vehicle bodyshell and with a traction battery, in which the traction battery can be attached compactly and space-savingly on the floor structure, and the traction battery is largely protected from deformation and hence from damage in the event of a collision of the motor vehicle with an obstacle. Also, the traction battery may be mounted on the floor structure with very little assembly work.

It is pointed out that the features listed individually in the claims may be combined with each other in any technically sensible manner and disclose further embodiments of the disclosure. The description characterizes and specifies the disclosure further, in particular in connection with the figures.

According to the disclosure, a motor vehicle with at least partially electric drive comprises a floor structure of a motor vehicle bodyshell and a traction battery that is arranged on an underside of the floor structure and is connected thereto. The floor structure has a central tunnel extending in the vehicle longitudinal direction and having a profile open towards the bottom. The central tunnel preferably has a substantially U-shaped cross-section. Furthermore, according to the disclosure, a plurality of reinforcing webs is arranged on the central tunnel, which stiffen the central tunnel and are fixedly connected thereto. Here, the traction battery is attached at least to some of the reinforcing webs. In the sense of the present disclosure, this means that the traction battery may be attached directly to the reinforcing webs, but may also be fixed with the interposition of a subframe in which the traction battery is received and substantially held. In the latter case, the subframe may—additionally or alternatively to the traction battery—be attached to the corresponding reinforcing webs.

Thus, the reinforcing webs firstly stabilize the central tunnel and at the same time offer (additional) fixing possibilities for fixing the traction battery to the floor structure. In the event of a collision of the motor vehicle with an obstacle, the central tunnel is largely protected from deformation by the reinforcing webs, since the reinforcing webs provide additional load paths for dissipating the collision forces introduced into the motor vehicle bodyshell and floor structure in a collision. In this way, the traction battery is effectively largely protected from deformation and any possible resulting damage from the collision.

In a case in which the traction battery, due to its structure, itself provides load paths for dissipating collision forces, for example by load braces provided in the battery or battery housing, the collision forces may be distributed over the load paths provided by the traction battery and the load paths provided by the reinforcing webs on the central tunnel, so that the mechanical loading on the traction battery in the event of a collision is substantially reduced.

A space-saving arrangement of the traction battery on the floor structure of the motor vehicle is achieved in that, by arranging the traction battery on at least some of the reinforcing webs of the central tunnel, additional fixing devices may be omitted that would otherwise be required on the floor structure of the motor vehicle bodyshell or the traction battery, for example fixing plates and/or fixing flanges, whereby the production complexity and hence the production costs of the motor vehicle and its weight can be reduced. Also, in comparison with a reinforcing plate arranged on the central tunnel, the reinforcing webs have the advantage of lower weight.

According to an advantageous embodiment of the disclosure, the open underside of the central tunnel is bridged at least by some of the reinforcing webs. Here, the reinforcing webs may bridge the central tunnel both substantially in the vehicle transverse direction, e.g. as transverse reinforcing webs, and also in a direction angled to the vehicle transverse direction, for example as diagonal reinforcing webs. Because the open underside of the central tunnel is bridged by at least some of the reinforcing webs, its open cross-section is closed, which leads to a further increase in the stiffness of the central tunnel. Also, the reinforcing webs running transversely and/or diagonally strengthen the central tunnel, in particular in relation to a side impact of an obstacle against the vehicle bodyshell in which the collision forces are introduced into the bodyshell and floor structure substantially in the vehicle transverse direction. These can then be dissipated by the reinforcing webs that are arranged substantially in the vehicle transverse direction on the central tunnel, and protect the central tunnel from deformation.

A further advantageous embodiment of the disclosure provides that at least some of the reinforcing webs extend substantially in the vehicle longitudinal direction. Thus, in particular, at least one additional load path is provided in the longitudinal direction of the central tunnel by the at least one reinforcing web running in the vehicle longitudinal direction. This strengthens the central tunnel in particular in relation to a frontal collision of the motor vehicle with an obstacle since, on a frontal collision, the collision forces act on the vehicle bodyshell and its floor structure substantially in the vehicle longitudinal direction, and can be dissipated by the at least one reinforcing web on the central tunnel running substantially in the vehicle longitudinal direction.

A further, equally advantageous embodiment of the disclosure provides that the reinforcing webs are bolted to the central tunnel. In particular with a view to easier installation of the reinforcing webs on the central tunnel, a bolted connection offers substantial advantages because of the very limited assembly space available for installation. Also, a bolted connection guarantees an adequate transfer of force between the reinforcing webs and the central tunnel in any action direction.

According to yet another advantageous embodiment of the disclosure, the traction battery is bolted to the reinforcing webs to which it is attached. In this case too, in particular with a view to easier installation of the traction battery on the reinforcing web or webs, a bolted connection offers substantial advantages because of the very limited assembly space available for installation. Also, a bolted connection guarantees an adequate transfer of force between the traction battery and the reinforcing web in any action direction.

In a further advantageous embodiment of the disclosure, the floor structure on both sides of the central tunnel has at least one crossmember extending substantially in the vehicle transverse direction and fixedly connected to the central tunnel by its end portion facing the central tunnel. Here, at least one reinforcing web is arranged bridging the central tunnel, such that it connects together the respective end portions of the crossmembers on both sides of the central tunnel. In this way, a closed load path is formed from the one crossmember on the one side of the central tunnel to the crossmember on the other side of the central tunnel, whereby in particular, side impact forces acting on the vehicle bodyshell and the floor structure can be dissipated by the cross members and reinforcing webs, which advantageously helps to avoid early deformation of the floor structure in the event of a collision.

The crossmember(s) may be a seat crossmember for fixing of a seat in a passenger cell of the motor vehicle. Seat crossmembers are safety-relevant components of a vehicle and therefore, in the event of a collision of the motor vehicle with an obstacle, must guarantee the position of the seating. Also, the seat crossmembers constitute an essential part of the lateral load path for the side impact forces introduced into the vehicle bodyshell on a side impact. They must therefore keep the deformation of the floor structure as low as possible, in order to ensure an adequate survival space for the occupants of the motor vehicle. This can be guaranteed with the arrangement according to the disclosure of the at least one reinforcing web relative to the transverse or seat transverse members, as described above.

According to a further advantageous embodiment of the disclosure, the reinforcing webs form a ladder frame structure which comprises at least two longitudinal reinforcing webs running substantially in vehicle longitudinal direction, and a plurality of transverse reinforcing webs connecting these two longitudinal reinforcing webs together and bridging the central tunnel. Such a ladder frame structure offers the central tunnel adequate stiffening in relation to both a frontal collision and a side collision, so that collision forces in the vehicle longitudinal direction can be effectively dissipated via the longitudinal reinforcing webs, and collision forces in the vehicle transverse direction can be effectively dissipated by the transverse reinforcing webs of the ladder frame.

Diagonal reinforcing webs running at an angle to the transverse reinforcing webs and also bridging the central tunnel may also form part of the ladder frame in order to stiffen this further. It is also conceivable, instead of the transverse reinforcing webs, to provide only diagonal reinforcing webs that are connected together via the respective longitudinal reinforcing webs. In this case, the traction battery is preferably attached to the diagonal reinforcing webs, for example bolted thereto.

With a view to simple installation, in the ladder frame arrangement of the reinforcing webs described above, in a particularly advantageous fashion the longitudinal reinforcing webs may be attached, preferably bolted, to the central tunnel, and the traction battery attached, preferably bolted, to at least some of the transverse reinforcing webs.

Yet a further advantageous embodiment of the disclosure provides that the traction battery extends to both sides of the central tunnel in the vehicle transverse direction, and that the region of the central tunnel has a tunnel-like recess extending in the vehicle longitudinal direction and following the central tunnel. Preferably, an exhaust system of an internal combustion engine of the motor vehicle runs in the recess. This embodiment constitutes a particularly compact arrangement of the traction battery on the floor structure of the vehicle bodyshell, although it extends to both sides of the central tunnel and is arranged below the central tunnel; when the traction battery is mounted, it blocks free access to the interior of the central tunnel, which could house the exhaust system, for example the exhaust pipe. The recess of the traction battery however offers the exhaust system substantially the same space as the central tunnel itself can provide, only slightly below the central tunnel.

Particularly advantageously are other line-like elements, for example brake lines, fuel lines and/or electrical lines, which preferably have a smaller diameter than the exhaust system, in particular the exhaust pipe, which may be accommodated in the intermediate or tunnel space running in the vehicle longitudinal direction, which is formed between a top side of the traction battery or the reinforcing webs bridging the central tunnel, and the central tunnel itself.

Preferably, the height of the recess in the traction battery is dimensioned such that the exhaust system, in particular an exhaust pipe, is completely received in the recess of the traction battery and consequently does not protrude downward beyond the underside of the traction battery. Thus the ground clearance of the motor vehicle can be further improved.

Further features and advantages of the disclosure arise from the following description of exemplary embodiments of the disclosure, which should not be interpreted restrictively and which are explained in more detail below with reference to the drawings. The drawings show diagrammatically:

### BRIEF DESCRIPTION OF THE DRAWINGS

FIG. 1 is a perspective view from below of a bodyshell, in particular a floor structure, of a motor vehicle according to an exemplary embodiment of the disclosure;

FIG. 2 is a perspective view from below of the floor structure of the bodyshell in FIG. 1;

FIG. 3 is a plan view of the floor structure from FIG. 2 from below;

FIG. 4 is a plan view of the floor structure from FIG. 3 from below and a partial cross-sectional view along section line A-A marked in the plan;

FIG. 5 is a plan view of the floor structure from FIG. 3 from below and a partial cross-sectional view along section line B-B marked in the plan;

FIG. 6 is a plan view of the floor structure from FIG. 3 from below and a partial cross-sectional view along section line C-C marked in the plan;

FIG. 7 is a first arrangement of line-like elements in a central tunnel of the floor structure from FIG. 6; and

FIG. 8 is a second arrangement of the line-like elements from FIG. 7.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In the various figures, parts of equivalent function carry the same reference numerals so these are usually only described once.

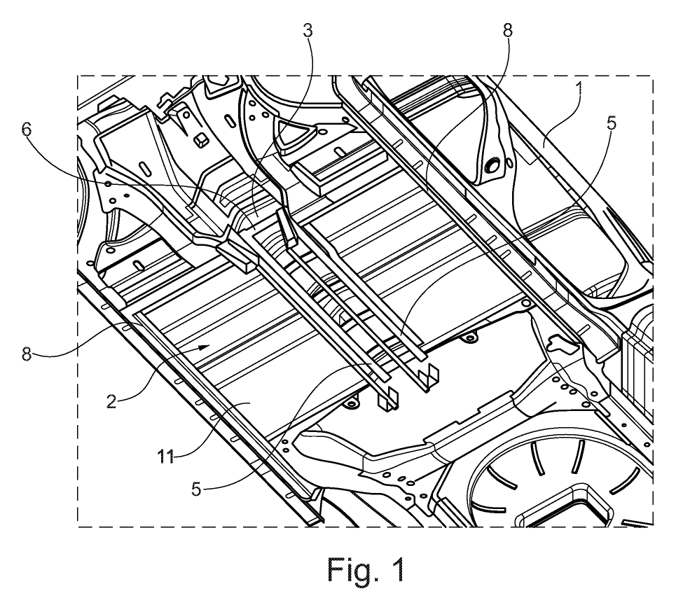

FIG. 1 shows a perspective view from below of a bodyshell 1 of the motor vehicle (not shown in detail) according to an exemplary embodiment of the disclosure. In the exemplary embodiment described here, the motor vehicle is a hybrid or plug-in hybrid vehicle which, as well as at least one electric motor (not shown), also has an internal combustion engine (also not shown).

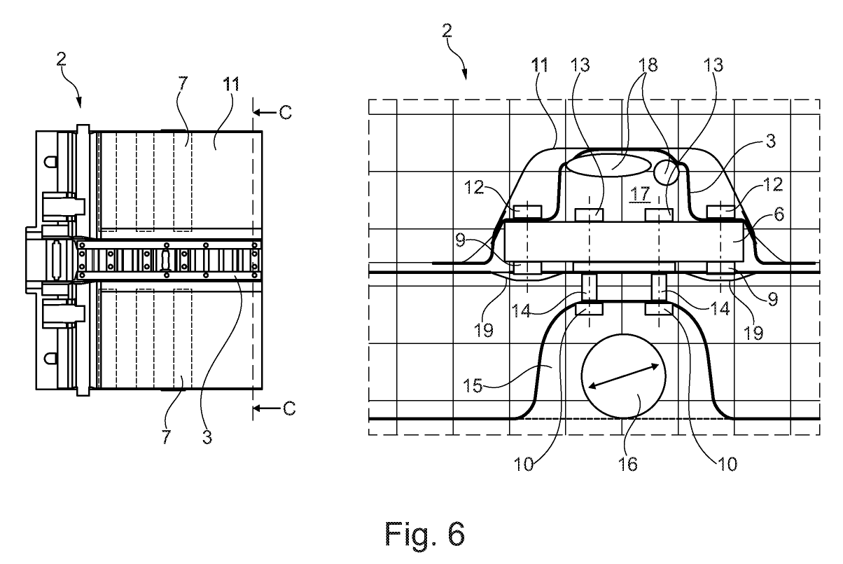

The vehicle bodyshell 1 comprises a floor structure 2, which has a central tunnel 3 running in the vehicle longitudinal direction and having a profile open at the bottom. In mounted state, a traction battery 4, which is not shown in FIG. 1, is arranged below the floor structure 2 (see e.g. FIG. 6) and is connected to the floor structure 2. As shown in FIG. 1, a plurality of reinforcing webs 5 and 6 is arranged on the central tunnel 3, which stiffen the central tunnel 3 and are fixedly connected thereto. In particular, in the exemplary embodiment shown in FIG. 1, the reinforcing webs comprise two longitudinal reinforcing webs 5 and five transverse reinforcing webs 6. In the exemplary embodiment shown in FIG. 1, the reinforcing webs 5 and 6 form a ladder frame structure comprising the longitudinal reinforcing webs 5 and the transverse reinforcing webs 6 connecting these longitudinal reinforcing webs 5 together. As will be explained in more detail below, in this exemplary embodiment, the traction battery 4 is attached to at least some of the reinforcing webs 6.

As shown in FIG. 1, the longitudinal reinforcing webs 5 extend substantially in the vehicle longitudinal direction, and the transverse reinforcing webs 6 extend substantially in the vehicle transverse direction. Accordingly, the open underside of the central tunnel 3 is bridged by some of the reinforcing webs 5, 6, namely here by the five transverse reinforcing webs 6, so that the open cross section of the central tunnel 3 is closed by the transverse reinforcing webs 6, achieving a substantial increase in the stiffness of the central tunnel 3. In particular, in the event of a side impact of an obstacle against the vehicle bodyshell 1, in which the collision forces are introduced into the bodyshell 1 and into the floor structure 2 substantially in the vehicle transverse direction, the transverse reinforcing webs 6 provide additional load paths in the vehicle transverse direction along which the collision forces can be dissipated, so that in this case the central tunnel 3 is protected from substantial deformation.

Furthermore, the longitudinal reinforcing webs 5 provide additional load paths in the vehicle longitudinal direction for the central tunnel 3, in particular in relation to a frontal collision of the motor vehicle with an obstacle, so that the collision forces acting in the vehicle longitudinal direction can also be effectively dissipated using the longitudinal reinforcing webs 5.

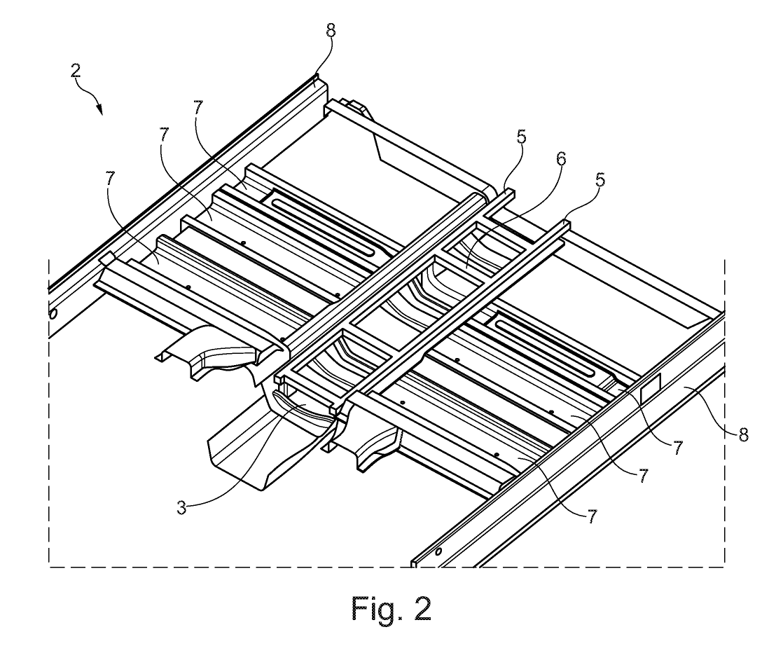

FIG. 2 shows a perspective view from below of the floor structure 2, alone, of the bodyshell 1 from FIG. 1. In the exemplary embodiment shown in FIG. 2, on both sides of the central tunnel 3, the floor structure 2 has three crossmembers 7 extending substantially in the vehicle transverse direction. As evident in FIG. 2, the respective end portions of the crossmembers 7 facing the central tunnel 3 are fixedly connected to the central tunnel 3. According to FIG. 2, the opposite end portions of the crossmembers 7 are each connected to a longitudinal member 8 on the left and right vehicle sides. In the exemplary embodiment shown, the crossmembers 7 are seat crossmembers for fixing of seats (not shown) in a passenger cell (also not shown) of the motor vehicle.

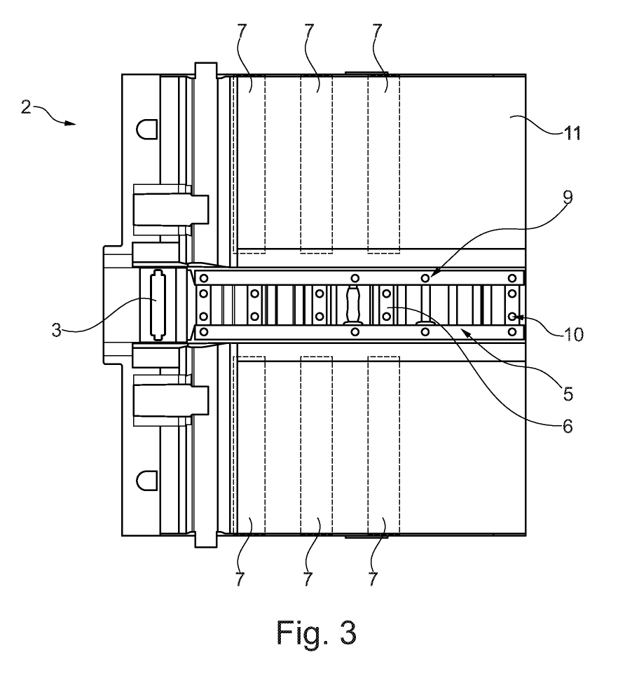

In FIG. 3, which shows a plan view of the floor structure from FIG. 2 from below, it is clear that in the exemplary embodiment shown, particularly preferably, some of the reinforcing webs 6 bridging the central tunnel 3 are arranged such that they connect together the respective end portions of the crossmembers 7 connected to the central tunnel 3 on both sides of the central tunnel 3. Thus, a closed load path is formed from a crossmember 7 on the one side of the central tunnel 3 to a respective corresponding crossmember 7 on the other side of the central tunnel 3, whereby in particular side impact forces acting on the vehicle bodyshell 1 and the floor structure 2 can be dissipated by the crossmembers 7 and the reinforcing webs 6 connecting these together, which advantageously helps avoid an early deformation of the floor structure 2 in the event of a collision. Accordingly, in the event of a collision of the motor vehicle with an obstacle, in particular on a side impact, the crossmembers 7 secure the position of the seating in the passenger cell and thus in this case guarantee an adequate survival space for the occupants of the motor vehicle.

Furthermore, FIG. 3 shows diagrammatically how the two longitudinal reinforcing webs 5 are each attached to the central tunnel 3 by a total of eight bolted connections 9, four bolted connections for each longitudinal reinforcing web 5. Moreover, two bolted connections 10 are shown for each transverse reinforcing web 6, which serve to bolt the traction battery 4 (see e.g. FIG. 6) to the reinforcing webs 6.

A floor panel 11 indicated in FIG. 3 closes the floor structure 2 towards the underside (facing the viewer). Since the crossmembers 7 are covered by the floor plate 2 in the depiction, these are accordingly drawn in dotted lines in FIG. 3.

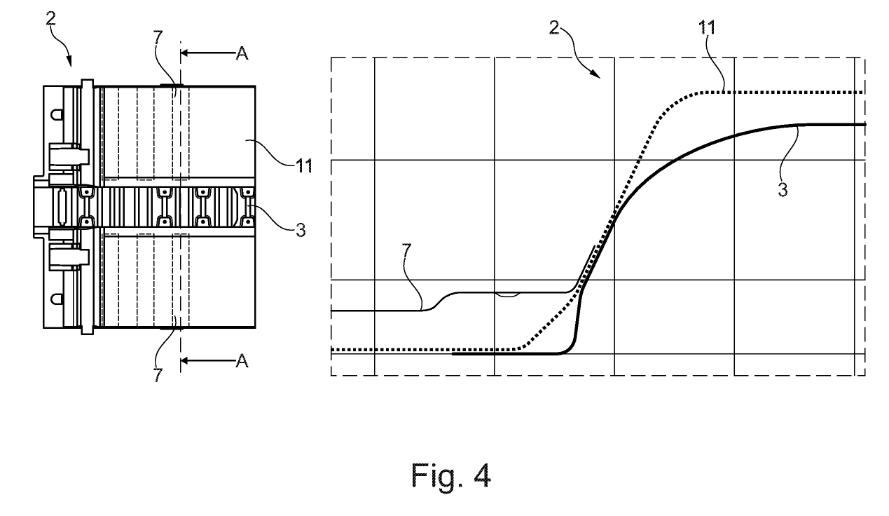

FIG. 4 shows a plan view of the floor structure 2 from FIG. 3 from below (left half of the image) and a partial cross-sectional view (right half of the image) along section line A-A shown in the plan. The partial cross-sectional view, because of the longitudinally symmetrical structure of the floor structure 2, shows only the left half of the total cross-section along section line A-A. The partial cross-sectional view of FIG. 4 clearly shows that the crossmember 7 (seat crossmember), at its end portion facing the central tunnel 3, is fixedly connected to the central tunnel 3, preferably welded thereto. According to the partial cross-sectional view of FIG. 4, in total three panels (end portion of crossmember 7, floor panel 11 and central tunnel 3) are connected together, preferably welded, at the fixing point of the crossmember 7 to the central tunnel 3.

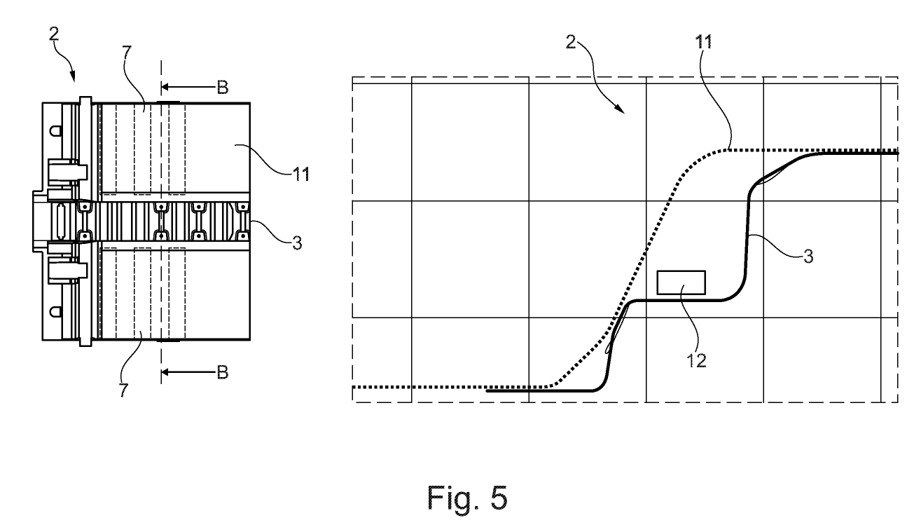

FIG. 5 shows a plan view of the floor structure 2 from FIG. 3 from below (left half of the image) and a partial cross-sectional view (right half of the image) along section line B-B shown in the plan. The partial cross-sectional view, because of the longitudinally symmetrical structure of the floor structure 2, shows only the left half of the total cross-section along section line B-B. The partial cross-sectional view of FIG. 5 shows that a weld nut 12 is provided on the top of the central tunnel 3 for the bolted connection 9 of the longitudinal reinforcing webs 5 (see FIG. 3). Accordingly, at this point the shape of the central tunnel 3 deviates from the otherwise substantially U-shaped cross-section into a corresponding bulge at which the weld nut 12 is attached. The weld nut 12 allows simple installation or bolting of the respective longitudinal reinforcing web 5 to the central tunnel 3 from the underside of the central tunnel 3.

FIG. 6 shows a plan view of the floor structure 2 from FIG. 3 from below (left image half) and a partial cross-sectional view (right image half) along section line C-C shown in the plan. The partial cross-sectional view of FIG. 6 shows how the traction battery 4 is connected to one of the plurality of transverse reinforcing webs 6, preferably bolted thereto by means of the bolted connection 10. For this, the transverse reinforcing web 6 on its top side has a weld nut 13 for each bolted connection 10. As shown in the partial cross-sectional view of FIG. 6, in the exemplary embodiment shown, the bolted connection 10 is preferably created by the spacer bush 14 bridging the traction battery 4 at this point. The weld nut 13 allows simple installation or bolting of the traction battery 4 to the respective transverse reinforcing web 6 from the underside of the transverse reinforcing web 6.

It is also clear from the partial cross-sectional view of FIG. 6 that the traction battery 4 extends to both sides of the central tunnel 3 in the vehicle transverse direction, and has in the region of the central tunnel 3 tunnel-like recesses 15 extending in the vehicle longitudinal direction (perpendicular to the image plane of the partial cross-sectional view) and following the central tunnel 3. In the exemplary embodiment shown, this recess 15 houses an exhaust system 16, in particular an exhaust pipe 16, of the internal combustion engine (not shown) of the motor vehicle. As shown in the partial cross-sectional view of FIG. 6, in the exemplary embodiment shown, the exhaust system 16 does not protrude beyond the underside of the traction battery 4, which guarantees an improved ground clearance of the motor vehicle.

In the exemplary embodiment shown in FIG. 6, advantageously, line-like elements 18, for example brake lines, fuel lines and/or electric lines, can be accommodated compactly and space-savingly in the intermediate or tunnel space 17 formed by the downwardly open profile of the central tunnel 3, between the top side of the traction battery 4 or the transverse reinforcing web 6 and the curvature of the central tunnel 3 running above this.

The partial cross-sectional view of FIG. 6 furthermore shows depressions 19 made in the top side of the traction battery 4 at the site of the bolted connections 9. These serve to create sufficient space for receiving the part of the bolted connection 9, for example a bolt head, protruding from the reinforcing web 5 or 6.

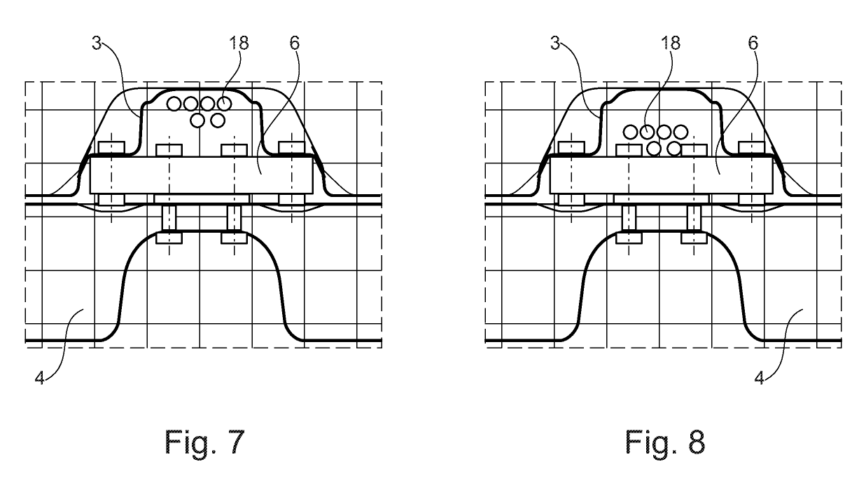

FIG. 7 shows a first specific arrangement of the line-like elements 18 from FIG. 6 in the central tunnel 3. FIG. 8 shows a second specific arrangement of the line-like elements 18 from FIG. 6. It is clear from FIG. 7 that the line-like elements 18, for example brake lines, fuel lines and/or electric lines and similar, which preferably have a smaller diameter than the exhaust system 16 shown in the partial cross-sectional view of FIG. 6, are attached to the inside of the central tunnel 3. In contrast, the lines 18 in FIG. 8 are attached to the reinforcing webs 5 and/or 6, and are preferably pre-assembled thereon before the reinforcing webs 5 and/or 6 are mounted on the central tunnel 3.

The motor vehicle according to the disclosure has been explained in detail with reference to exemplary embodiments shown in the figures. The motor vehicle is not however restricted to the embodiments described herein, but also comprises further embodiments with similar function.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A motor vehicle with at least partially electric drive, comprising:
a floor of a bodyshell;
a traction battery arranged on and connected to an underside of the floor, the floor having a tunnel extending in a vehicle longitudinal direction and a profile open towards the underside; and
a plurality of reinforcing webs arranged on and fixedly connected to the tunnel, wherein the traction battery is attached to at least one of the webs.

2. The motor vehicle as claimed in claim 1, wherein the open underside of the tunnel is bridged by at least two of the plurality of reinforcing webs.

3. The motor vehicle as claimed in claim 1, wherein at least two of the plurality of reinforcing webs extend substantially in the longitudinal direction.

4. The motor vehicle as claimed in claim 1, wherein the plurality of reinforcing webs are bolted to the tunnel.

5. The motor vehicle as claimed in claim 1, wherein the traction battery is bolted to the plurality of reinforcing webs.

6. The motor vehicle as claimed in claim 1 further comprising at least one crossmember, disposed on the floor, extending substantially in a transverse direction, and fixedly connected to the tunnel with an end portion facing the tunnel such that at least one of the plurality of reinforcing webs bridges the tunnel to connect the end portion of the crossmember on each side of the tunnel.

7. The motor vehicle as claimed in claim 6, wherein the crossmember is a seat crossmember for fixing of a seat.

8. The motor vehicle as claimed in claim 1, wherein the plurality of reinforcing webs form a ladder frame structure having at least two longitudinal reinforcing webs running substantially in the longitudinal direction, and a plurality of transverse reinforcing webs extending in a transverse direction to connect the at least two longitudinal reinforcing webs and bridge the tunnel.

9. The motor vehicle as claimed in claim 8, wherein the longitudinal reinforcing webs are attached to the tunnel and the traction battery is attached to at least two of the transverse reinforcing webs.

10. The motor vehicle as claimed in claim 6, wherein the traction battery extends to both sides of the tunnel in the transverse direction, and the tunnel defines a tunnel-like recess extending in the longitudinal direction and follows the tunnel to house an exhaust system of an internal combustion engine.

11. A bodyshell for a vehicle comprising:
a floor having an underside and defining a tunnel extending in a longitudinal direction having a profile being open towards the underside; and
a plurality of reinforcing webs extending in the longitudinal direction and a transverse direction fixedly connected to and bridged across the tunnel such that a traction battery is supported by at least one of the plurality of reinforcing webs in the transverse direction and the tunnel is supported by at least two of the plurality of reinforcing webs in the longitudinal direction.

12. The bodyshell as claimed in claim 11, wherein the tunnel is bridged by at least two of the plurality of reinforcing webs.

13. The bodyshell as claimed in claim 11 further comprising a crossmember disposed on the floor, extending substantially in the transverse direction, and fixedly connected to the tunnel with an end portion facing the tunnel such that at least two of the plurality of reinforcing webs bridges the tunnel to connect the end portion of the crossmember on each side of the tunnel.

14. The bodyshell as claimed in claim 11, wherein the plurality of reinforcing webs form a ladder frame structure having at least two reinforcing webs running substantially in the longitudinal direction, and at least one reinforcing web extending in a transverse direction to connect the at least two reinforcing webs running in the longitudinal direction and bridge the tunnel.

15. The bodyshell as claimed in claim 11, wherein the traction battery extends to both sides of the tunnel in the transverse direction, and the tunnel defines a recess extending in the longitudinal direction to house an exhaust system of an internal combustion engine.

16. A floor for a vehicle bodyshell comprising:
a plurality of reinforcing webs, extending in longitudinal and transverse directions, fixedly connected to and bridged across a tunnel defined on an underside of the floor such that a traction battery is supported by the transversely-extending reinforcing webs and the tunnel is supported by the longitudinally-extending reinforcing webs.

17. The floor as claimed in claim 16 further comprising a crossmember disposed on the floor, extending substantially in the transverse direction, and fixedly connected to the tunnel with an end portion facing the tunnel such that at least two of the plurality of reinforcing webs bridges the tunnel to connect the end portion of the crossmember on each side of the tunnel.

18. The floor as claimed in claim 16, wherein the plurality of reinforcing webs form a ladder frame structure such that at least two reinforcing webs run substantially in the longitudinal direction, and at least one reinforcing web extends in the transverse direction to connect the at least two reinforcing webs running in the longitudinal direction and bridge the tunnel.

19. The floor as claimed in claim 16, wherein a traction battery extends to both sides of the tunnel in the transverse direction, and the tunnel defines a recess extending in the longitudinal direction to house an exhaust system.

20. The floor as claimed in claim 16, wherein the tunnel is bridged by at least two of the plurality of reinforcing webs.
